(19) United States
(12) Patent Application Publication
(10) Pub. No.: US 2010/0212228 A1
(43) Pub. Date: Aug. 26, 2010

(54) FASTENING MECHANISM

(75) Inventors: Yi-Ming Chang, Taipei City (TW); Min-Chun Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/424,532

(22) Filed: Apr. 15, 2009

(30) Foreign Application Priority Data
Feb. 24, 2009 (TW) 98105784

(51) Int. Cl. E05F 11/24

(52) U.S. Cl. 49/346

(57) ABSTRACT

A fastening mechanism suitable for being assembled into a device having a housing is provided. The fastening mechanism includes a post, a latching element, at least a plunger assembly, and an operating element. The latching element has at least an opening, the plunger assembly is disposed at a side of the latching element, and the operating element is in contact with the latching element. The post passes through the opening and presses against the plunger assembly and the post is confined by the latching element when the operating element is in a locking position. The operating element drives the latching element to move horizontally relative to the latching element so as to release the post from confinement and the plunger assembly moves vertically relative to the latching element so as to push the post out of the opening when the operating element moves to an unlocking position.

### CROSS-REFERENCE TO RELATED APPLICATION

This application claims the priority benefit of Taiwan application serial no. 98105784, filed on Feb. 24, 2009. The entirety of the above-mentioned patent application is hereby incorporated by reference herein and made a part of specification.

### BACKGROUND OF THE INVENTION

1. Field of the Invention

The present invention relates to a fastening mechanism and more particularly, to a fastening mechanism which can simplify an assembly process.

2. Description of Related Art

When using a notebook computer, a user first has to push a knob switch in the front of the notebook computer to open the notebook computer for operations thereon. FIGS. 1A and 1B are schematic views of a conventional notebook computer and a structure of a switch thereof. As shown in FIGS. 1A and 1B, an upper cover 30 of the notebook computer has an operation lever 31, a knob switch 32, and a spring 33 connected to the operation lever. The operation lever 31 has a locking hook 31a and a base 40 of the notebook computer has a locking groove 41 corresponding to the locking hook 31a. The locking hook 31a can lock into the locking groove 41 such that the upper cover 30 of the notebook computer can be fastened with the base 40.

In addition, the knob switch 32 is disposed on an edge of the upper cover 30 for convenience of usage for the user. Therefore, when the user closes the upper cover 30 with the base 40, the user pushes the knob switch 32 such that the operation lever 31 moves and at the same time the spring 33 is extended and thus the locking hook 31a and the locking groove 41 are locked to each other and the upper cover 30 and the base 40 are in a closed state. When the user is to open the upper cover 30, the user again pushes the knob switch 32 to make the operation lever 31 move for a suitable distance so that the locking hook 31a is released from the locking groove 41 and the upper cover 30 and the base 40 may separate from each other. At this time, the resilience of the spring 33 causes the operation lever 31 to move to the original position.

Furthermore, the notebook computer can also include a knob and latch assembly. However, such an assembly requires reserving an opening on the upper cover for exposing the knob. Furthermore, if the knob and latch combination is not precisely matched, loosening or wobbling may occur. As a result, a significant amount of costs for material and labor are squandered away.

### SUMMARY OF THE INVENTION

The present invention provides a fastening mechanism which saves costs and simplifies an assembly process.

The present invention provides a fastening mechanism suitable for being assembled into a device having a housing. The fastening mechanism includes at least a post, a latching element, at least a plunger assembly, and an operating element. The latching element has at least an opening. The plunger assembly is disposed at a side of the latching element and the operating element is in contact with the latching element. When the operating element is in a locking position, the post is inserted into the opening and presses against the plunger assembly and the post is confined by the latching element. When the operating element moves to an unlocking position, the operating element drives the latching element to move horizontally in relation to the post so that the latching element releases the post from confinement and the plunger assembly moves vertically in relation to the latching element to push the post out of the opening.

In one embodiment of the fastening mechanism of the present invention, the operating element is a pressing element.

In one embodiment of the fastening mechanism of the present invention, the operating element is a sliding element.

In one embodiment of the fastening mechanism of the present invention, the operating element has a first inclined plane for guiding the latching element to move horizontally. In addition, the fastening mechanism may further include a guiding block disposed on the latching element, wherein the guiding block has a second inclined plane contacting with the first inclined plane.

In one embodiment of the fastening mechanism of the present invention, the fastening mechanism further includes an elastic component connected to the latching element to force the horizontally-moved latching element travel in a reverse direction.

In one embodiment of the fastening mechanism of the present invention, the operating element is a flat linking element.

In one embodiment of the fastening mechanism of the present invention, the latching element is a sliding bracket.

In one embodiment of the fastening mechanism of the present invention, the plunger assembly includes a plunger and a plunging elastic element, wherein the plunger is disposed on the plunging elastic element and the plunging elastic element has a push force after being deformed. In addition, the plunger assembly further includes a stopping portion disposed on the plunging elastic element, for limiting a distance of a return movement of the horizontally-moved latching element in the unlocking situation. Furthermore, the plunger assembly further includes an assisting elastic element to increase a push force of the plunger assembly, wherein the assisting elastic element and the plunger are respectively disposed on two sides of the plunging elastic element. The assisting elastic element and the plunging elastic element may be integrally formed.

In one embodiment of the fastening mechanism of the present invention, the plunging elastic element is an elastic plate and the assisting elastic element is an elastic plate parallel to the plunging elastic element.

In one embodiment of the fastening mechanism of the present invention, the plunging elastic element and the assisting elastic element are respectively assembled into the housing.

In one embodiment of the fastening mechanism of the present invention, the assisting elastic element is a spring, the housing has a first housing and a second housing, the first housing is suitable for opening and closing relatively to the second housing, the post is in the first housing, and the latching element, the plunger assembly, and the operating element are disposed in the second housing. In addition, the second housing includes a third housing and a fourth housing, the plunging elastic element is assembled in the third housing, and the assisting elastic element is disposed in the fourth housing.

In light of the above, the post, latching element, and plunger assembly of the fastening mechanism of the present invention may be formed of sheet metal so an amount of magnesium and aluminum castings in the device can be decreased, resulting in lowered costs and simplified assembly process.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic views of a conventional notebook computer and a structure of a switch thereof.

FIG. 2A is a schematic view of a device according to a first embodiment of the present invention.

FIG. 2B is a schematic view of the fastening mechanism assembled in the device in FIG. 2A.

FIG. 3 is a schematic view of a latching element and a guiding block in FIG. 2B.

FIG. 4 is a partial schematic view of the fastening mechanism assembled in a second housing.

FIG. 5 is a schematic view of a plunger assembly.

FIG. 6 is a schematic view of the plunger assembly in FIG. 5 from another perspective.

FIG. 7 is a schematic view of an operating element and a second housing.

FIG. 8 is a partial cross-sectional view of a device.

FIG. 9 is a schematic perspective view of FIG. 8.

FIG. 10 is a schematic view of a latching element in an unlocking position.

FIG. 11 is a partial schematic cross-sectional view of FIG. 10.

FIG. 12 is a partial schematic view of a device according to a second embodiment of the present invention.

FIG. 13 is a schematic view illustrating an assembly of a second housing and an assisting elastic element of the device in FIG. 12.

FIG. 14A is a schematic view of the fastening mechanism and a third housing when the latching element is in a locking position.

FIG. 14B is a schematic cross-sectional view of FIG. 14A.

FIG. 15A is a schematic view of the fastening mechanism and the third housing when the latching element is moving.

FIG. 15B is a schematic cross-sectional view of FIG. 15A.

FIG. 16A is a schematic view of the fastening mechanism and the third housing when the latching element is in an unlocking position.

FIG. 16B is a schematic cross-sectional view of FIG. 16A.

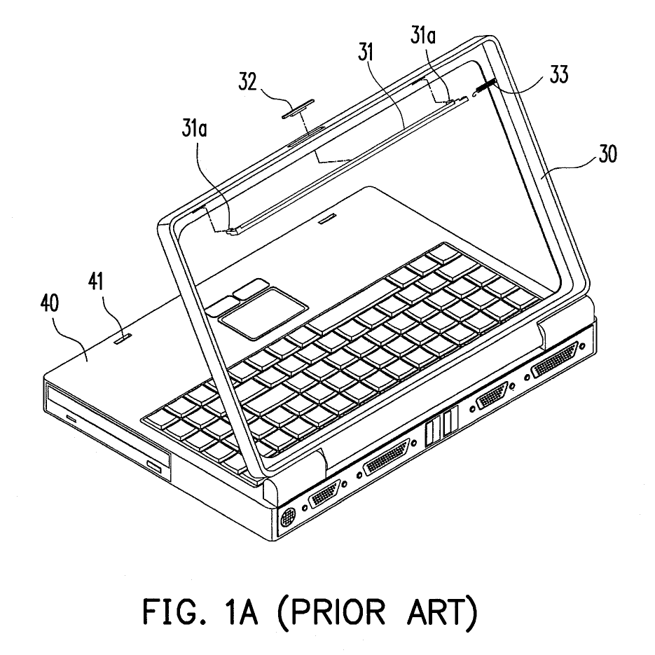

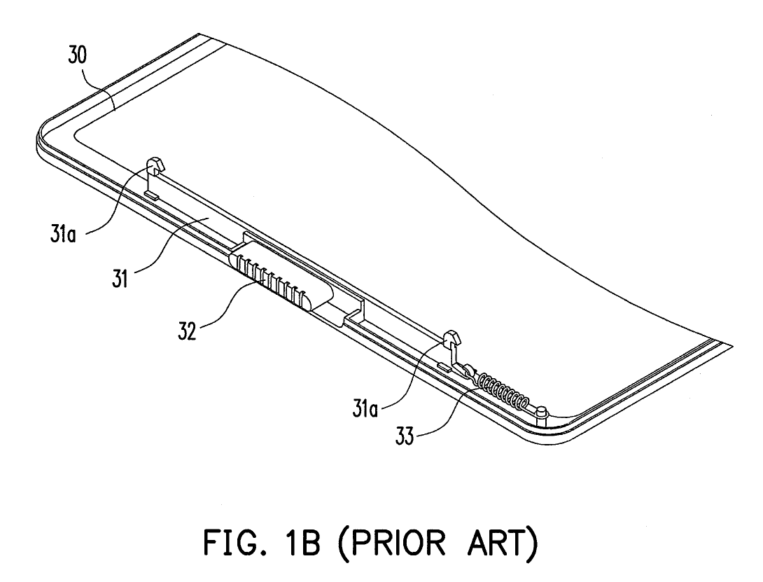

### DESCRIPTION OF EMBODIMENTS

The fastening mechanism of the present invention can be assembled into any device having a housing. In the background section, a notebook computer was used as an example to describe the related art, and thus embodiments of the invention will be described below using notebook computers as examples as well. However, based on their needs, persons of ordinary skill in the art are able to assemble the fastening mechanism of the present invention into any device, which is not limited to the notebook computer. The device may be any object requiring fastening such a briefcase or a suitcase.

### First Embodiment

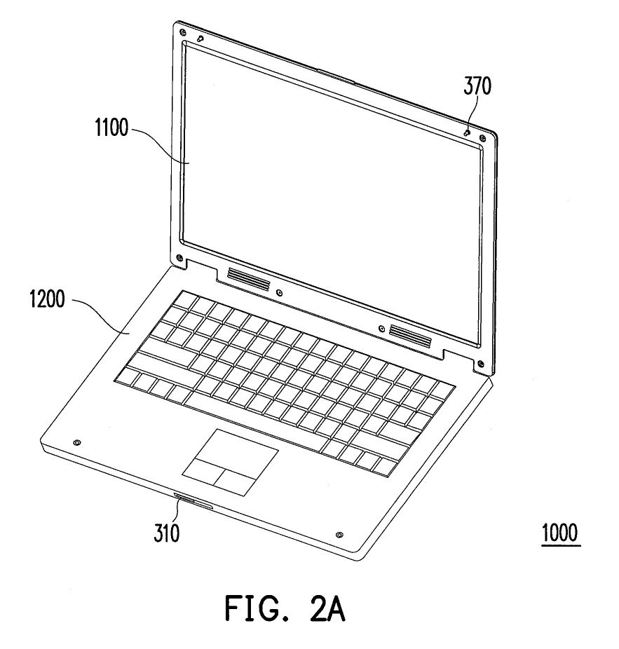

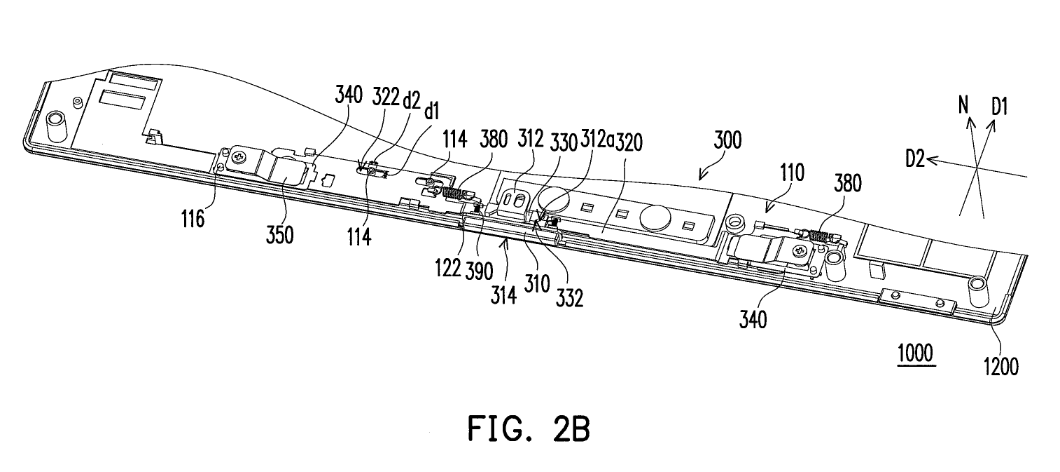

FIG. 2A is a schematic view of a device according to the first embodiment of the present invention and FIG. 2B is a schematic view of the fastening mechanism assembled in the device in FIG. 2A. Referring to both FIGS. 2A and 2B, a device 1000 may be a notebook computer having a housing including a first housing 1100 and a second housing 1200. The first housing 1100 opens and closes relatively to the second housing 1200. A fastening mechanism 300 is assembled in the device 1000 and includes a post 370, a latching element 320, a plunger assembly 340, and an operating element 310. The post 370 is in the first housing 1100. The latching element 320 has at least an opening 112. The plunger assembly 340 is disposed at a side of the latching element 320. The operating element 310 is in contact with the latching element 320.

From the above description, the operating element 310 has a first inclined plane 312a to guide the latching element 320 move horizontally. In addition, the fastening mechanism 300 may further include a guiding block 330 disposed on the latching element 320. The guiding block 330 has a second inclined plane 332 contacting with the first inclined plane 312a.

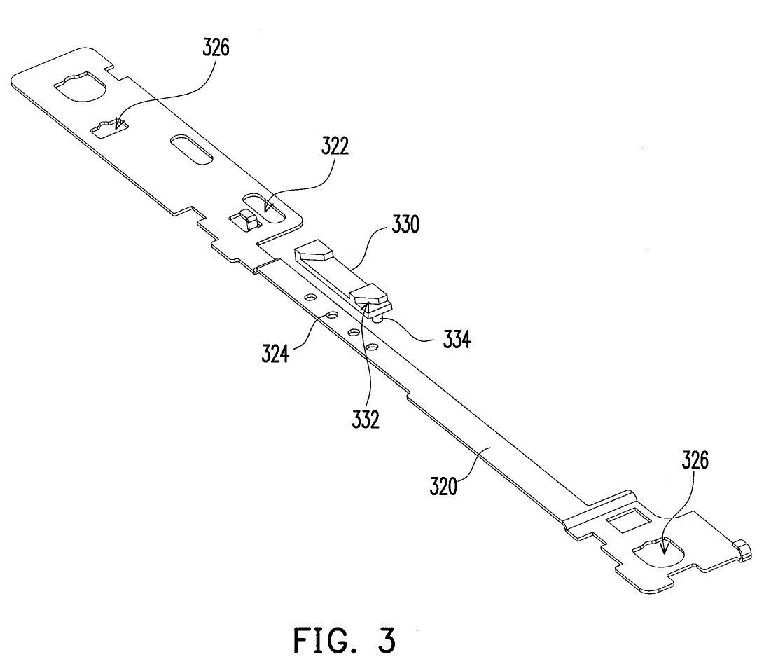

The operating element 310 has an assembly end 312 and a press flange 314. The assembly end 312 is assembled in the second housing 1200. The latching element 320 is disposed on an inside surface 110 of the second housing 1200. In the present embodiment, the operating element 310 is a pressing element. FIG. 3 is a schematic view of the latching element and a guiding block in FIG. 2B. Referring to both FIGS. 2B and 3, the inside surface 110 of the second housing 1200 has a plurality of assembly pillars 114. The latching element 320 is, for example, a flat linking element or a sliding bracket, and has a plurality of slots 322. The assembly pillar 114 passes correspondingly through the slot 322 to allow the latching element 320 to move horizontally. The match between the slot 322 and the assembly pillar 114 can limit the moving distance of the latching element 320. The latching element 320 is made of metal material and thus the latching element 320 has better rigidity and extended longevity. In addition, the width of two ends of the latching element 320 may be larger than the width of a middle portion of the latching element 320. As such, the narrower middle portion can make room for other elements to be disposed in the device 1000. Furthermore, the latching element 320 may have a plurality of assembly holes 324 located at the middle portion of the latching element 320. The guiding block 330 has a plurality of convex pillars 334 at a bottom surface facing the latching element 320. Shape of the convex pillar 334 may be cylindrical and the convex pillars 334 pass correspondingly through the assembly holes 324 of the latching element 320 so that the guiding block 330 is assembled onto the latching element 320.

It should also be mentioned that the operating element 310 is usually made of plastic material because the operating element 310 is exposed to the outside environment and the material of operating element 310 is usually chosen to be the same as the material of the housing of the device 1000 such that the overall exterior of the device 1000 is more appealing and is more easily formed. Moreover, since the second inclined plane 332 of the guiding block 330 is to be in contact with the first inclined plane 312a of the operating element 310, materials of the second inclined plane 332 and the first inclined plane 312a are both plastic so as to avoid abrasion as well as noise. Simply speaking, material of the guiding block 330 is usually chosen to be plastic to prevent annoying noise and abrasion from happening when the first inclined plane 312a comes in contact with the second inclined plane 332.

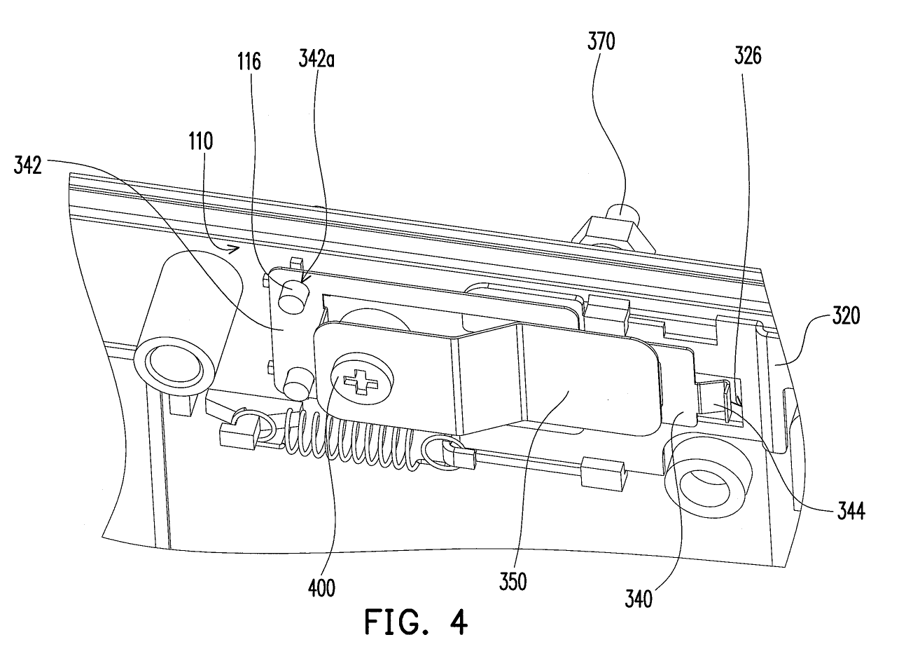

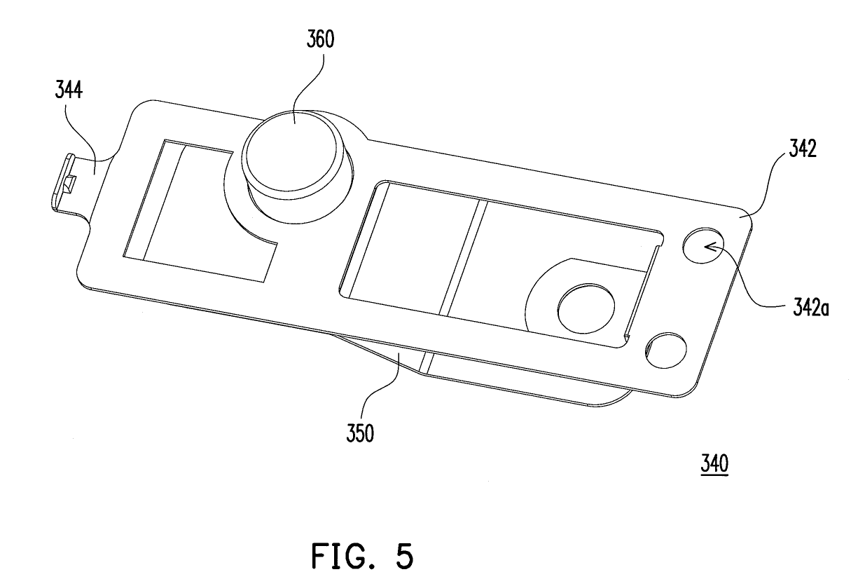

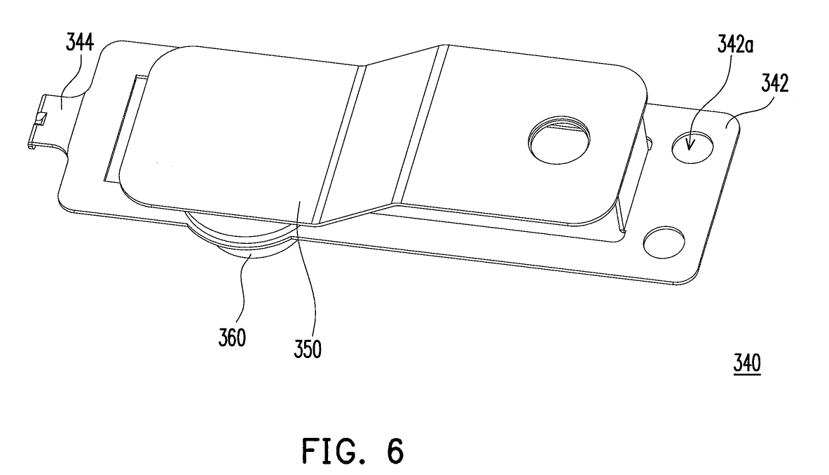

Continuously referring to FIG. 2B, the fastening mechanism 300 of the present embodiment has two plunger assemblies 340 respectively disposed at the two ends of the latching element 320. FIG. 4 is a partial schematic view of the fastening mechanism assembled in the second housing. FIG. 5 is a schematic view of the plunger assembly. FIG. 6 is a schematic view of the plunger assembly in FIG. 5 from another perspective. Referring to all FIGS. 4, 5, and 6, the plunger assembly 340 includes a plunger 360 and a plunging elastic element 342. The plunger 360 is disposed on the plunging elastic element 342 and in contact with the post 370. As shown in FIG. 4, one end of each plunging elastic element 342 is fixed on the inside surface 110 of the second housing 1200 and the other end is a free end. The plunging elastic element 342 has a push force after being deformed to drive the plunger 360 to suitably move in a normal direction N of the inside surface 110. In other words, the plunger assembly 340 moves vertically in relation to the latching element 320 to push on the post 370.

The plunger assembly 340 further includes an assisting elastic element 350 to increase the push force of the plunging elastic element 342, wherein the assisting elastic element 350 and the plunger 360 are respectively disposed on two sides of the plunging elastic element 342. In the present embodiment, the assisting elastic element 350 may be integrally formed with the plunging elastic element 342. For example, the assisting elastic element 350 may be formed by cutting a portion of the plunging elastic element 342 and bending the cut portion. In other embodiments, the assisting elastic element 350 may not be integrally formed with the plunging elastic element 342 and may be an elastic plate parallel to the plunging elastic element 342. The assisting elastic element 350 and the plunging elastic element 342 are respectively assembled into the housing.

The inside surface 110 of the second housing 1200 may have a plurality of positioning pillars 116 whose shape is cylindrical, for example. The plunging elastic element 342 of each plunger assembly 340 has two first position holes 342a correspondingly disposed on the positioning pillars 116.

In addition, each plunger assembly 340 further includes a stopping portion 344 which is a locking hook, for example. The latching element 320 has two limiting openings 326 which may be at the two wider ends of the latching element 320 (as shown in FIG. 3). When the latching element 320 slides in relation to the second housing 1200, the stopping portion 344 presses against an edge of the limiting opening 326 to limit a distance of a return movement of the horizontally-moved latching element 320. In the present embodiment, the stopping portion 344 is disposed on the plunging elastic element 342 and on one end of the plunging elastic element 342, for example. In addition, the plunger assembly 340 may be secured onto the second housing 1200 with a plurality of locking elements 400 which may be screws or studs.

Continuously referring to FIG. 2B, the device 1000 further includes an elastic element 380. One end of the elastic element 380 is connected to the latching element 320 and the other end is connected to the inside surface 110 of the second housing 1200. The elastic element 380 shown in FIG. 2B may be a compression spring. The position of the elastic element 380 shown in FIG. 2B is for illustration only. The location and number of the elastic element 380 of the present invention may be modified according to requirement without departing from the scope of the present invention.

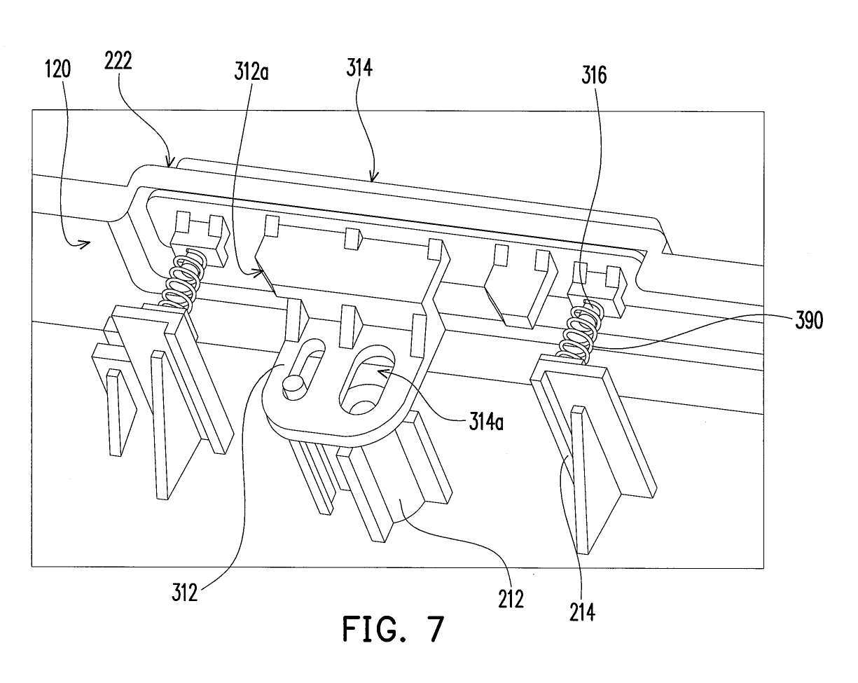

FIG. 7 is a schematic view of the operating element and the second housing. Referring to both FIGS. 2B and 7, the second housing 1200 further has a side surface 120 which has an opening 222 exposing a press flange 314 of the operating element 310. The second housing 1200 further includes a plurality of convex pillars 212. The assembly end 312 of the operating element 310 has a plurality of openings 314a which may be regarded as chutes. The convex pillars 212 pass correspondingly through the openings 314a so that the operating element 310 may move in relation to the convex pillars 212 via the openings 314a after being pressed.

The second housing 1200 further has two protruding structures 214. The operating element 310 has two positioning pillars 316. The fastening mechanism 300 further includes two compression springs 390. One end of the compression spring 390 is disposed correspondingly on the positioning pillar 316 of the operating element 310 and the other end of the compression spring 390 is connected to the protruding structure 214.

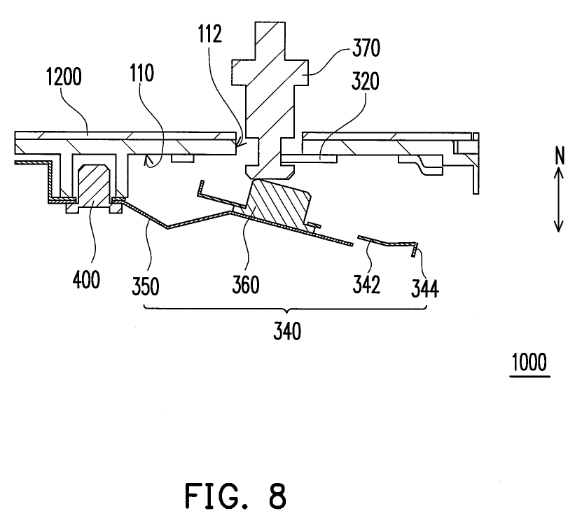

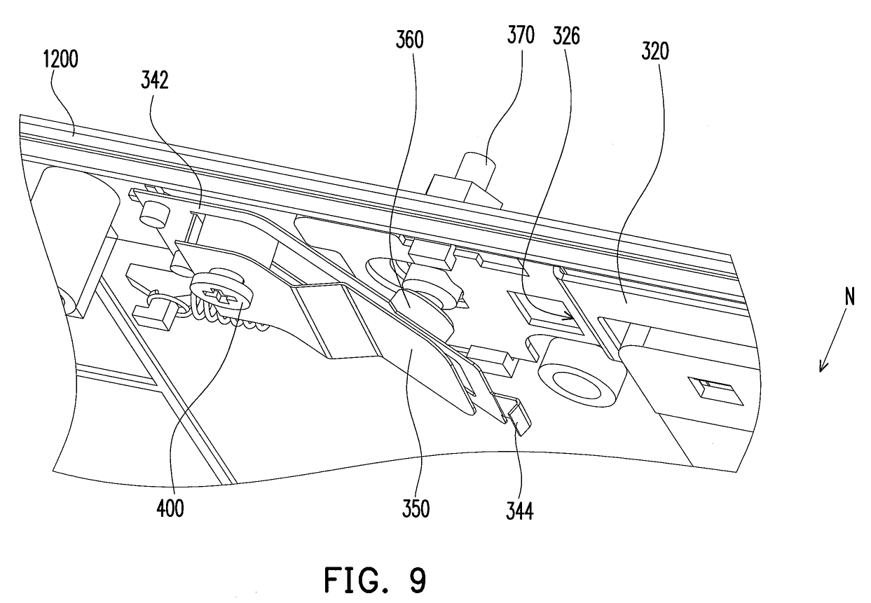

FIG. 8 is a partial cross-sectional view of a device. FIG. 8 illustrates the fastening mechanism in a locking position and FIG. 9 is a schematic perspective view of FIG. 8. Referring to FIGS. 2A, 8, and 9, the time when the latching element 320 is in a locking position is usually when the first housing 1100 and the second housing 1200 of the device 1000 are closed together. At this time, the weight of the first housing 1100 applies a force on the plunger 360 through the post 370 such that an end of the plunging elastic element 342 and an end of the assisting elastic element 350 move vertically in relation to the latching element 320 (i.e. inclining downward in the normal direction N). It should be noted that the assisting elastic element 350 is squeezed and is thereby deformed such that the assisting elastic element 350 retains resilience.

FIG. 4 is a schematic view of the latching element 320 moving toward the unlocking position. Referring to all FIGS. 2B, 4, and 7, when a user opens the device 1000, the user presses the press flange 314 of the operating element 310 in a direction D1. At this time, the operating element 310 moves in the direction D1 through the match between the opening 314a of the assembly end 312 and the convex pillar 212. After the user stops pressing the press flange 314, the resilience of the compression spring 390 pushes the operating element 310 to return to the original position.

Referring to FIGS. 2B and 4, after the user presses the press flange 314 of the operating element 310 in the direction D1, the first inclined plane 312a of the assembly end 312 of the operating element 310 pushes the second inclined plane 332 of the guiding block 330 such that the guiding block 330 drives the latching element 320 to move in relation to the second housing 1200. A width d1 of the slot 322 of the latching element 320 is equal to a diameter d2 of the assembly pillar 114 of the inside surface 110 so the latching element 320 is prevented from moving in the direction D1 and can only move in the direction D2. At the same time, the resilience of the originally stretched elastic element 380 drives the latching element 320 to move in the direction D2 (reverse direction). When the latching element 320 starts to move, the confinement of the post 370 is released. Therefore, the resilience of the assisting elastic element 350 facilitates the plunging elastic element 342 of the plunger assembly 340 and the post 370 to move upward in the normal direction N.

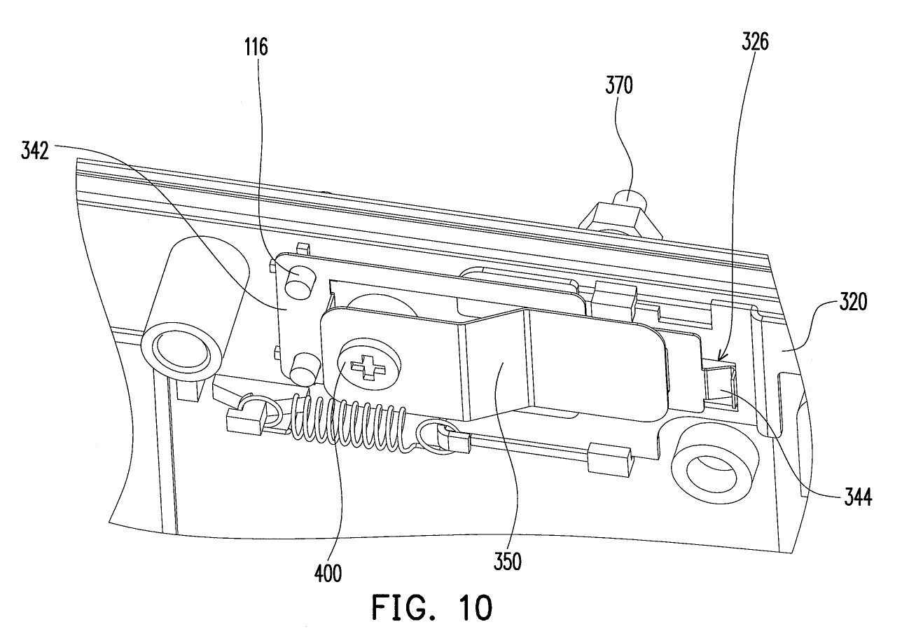

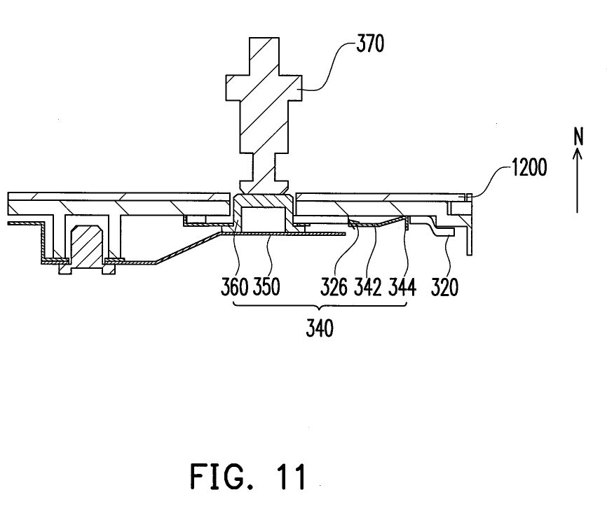

FIG. 10 is a schematic view of the latching element in an unlocking position. FIG. 11 is a partial schematic cross-sectional view of FIG. 10. Referring to all FIGS. 2B, 10, and 11, when the latching element 320 moves in the direction D2 to the unlocking position, the stopping portion 344 of the plunger assembly 340 presses against an edge of the limiting opening 326 of the latching element 320 to limit a movement distance of the latching element 320.

In particular, the plunger assembly, assisting elastic element, plunger, latching element of the fastening mechanism in the present embodiment are not small-sized precision elements and therefore have the advantage of easy installation. In addition, the number of elements is relatively less than that in the conventional technology, thereby providing assembly personnel with convenience of installation and simplification in the assembly process. Moreover, the latching element of the fastening mechanism moves horizontally in a direction parallel to the inside surface and the assisting elastic element and the plunger move vertically in a direction perpendicular to the inside surface, and such movements in two directions can reduce moving distance of the latching element and thus enable more ideal configuration of other electronic components in the device or effectively minimize overall size of the electronic device.

The above-mentioned configuration positions, connection relationship, and movement of the elements of the fastening mechanism are for example only. The designer may modify the elements used, configuration positions, connection relationship, and movement of the elements according to requirement or according to influences from the types, sizes, and positions of other elements in the device. For example, although the user makes the operating element move to drive the latching element with a pressing action, in other embodiments, the user may also make the operating element move to drive the latching element with a pushing action. Relevant co-movement relationships may also be modified correspondingly and appropriately.

### Second Embodiment

The present embodiment is mostly similar to the first embodiment, wherein same or similar reference numerals are used to denote same or similar elements. Differences between the present embodiment and the first embodiment are illustrated in detail below.

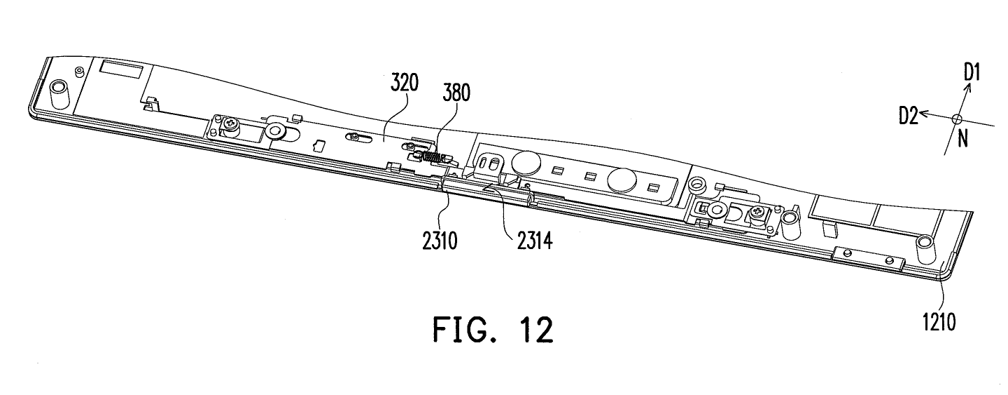

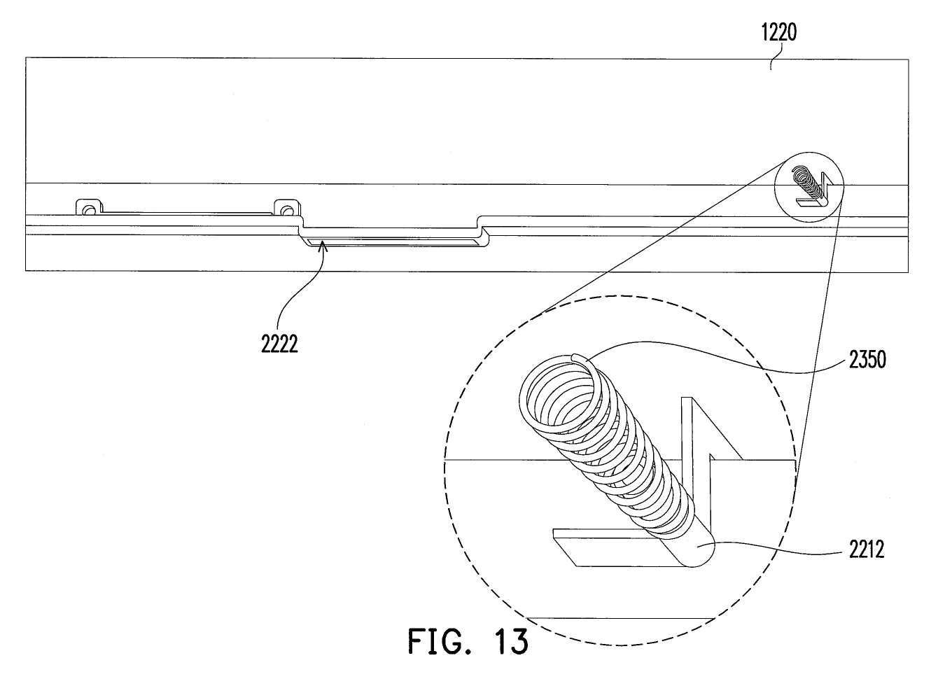

FIG. 12 is a partial schematic view of a device according to the second embodiment of the present invention and FIG. 13 is a schematic view of an assembly of a second housing and an assisting elastic element of the device in FIG. 12. Referring to both FIGS. 12 and 13, the second housing 1200 of the present embodiment may include a third housing 1210 and a fourth housing 1220. An operating element 2310 of the present embodiment is movably inserted in an opening 2222 on a side of the third housing 1210. An assisting elastic element 2350 is a spring. A bottom surface of the fourth housing 1220 has a plurality of positioning pillars 2212 and one end of the assisting elastic element 2350 is disposed on the positioning pillar 2212.

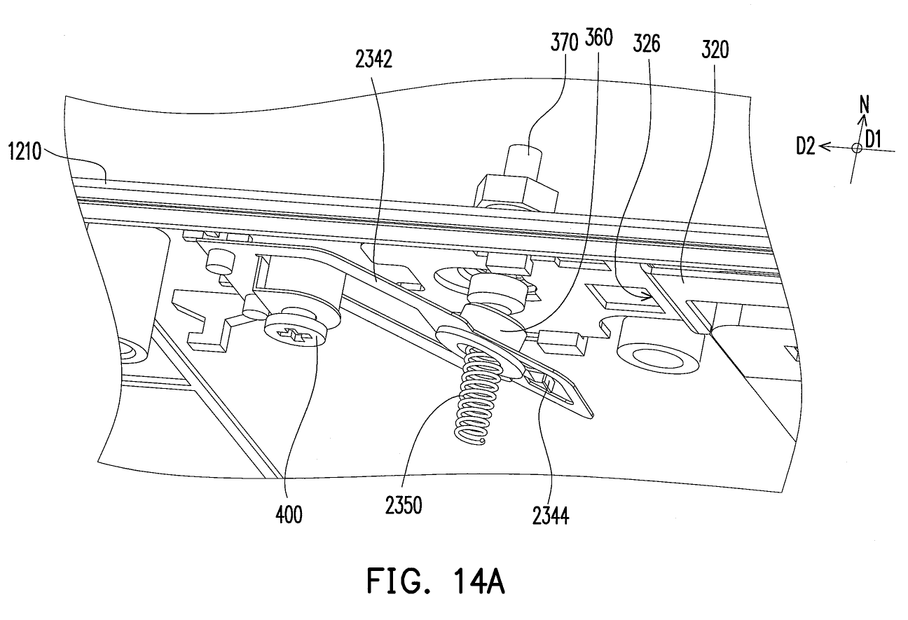

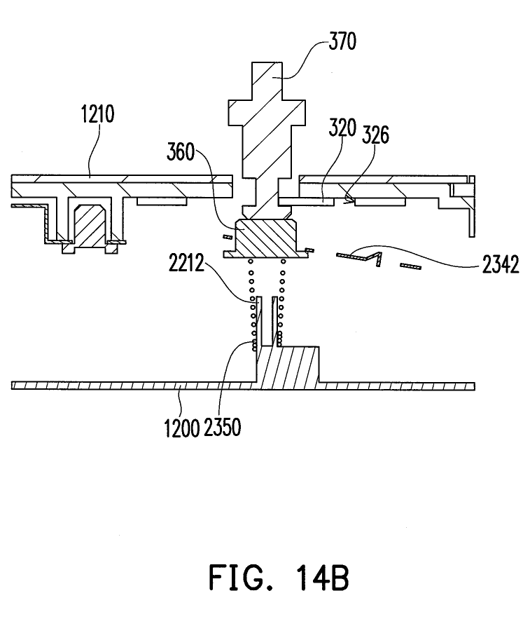

FIG. 14A is a schematic view of the fastening mechanism and the third housing when the latching element is in a locking position and FIG. 14B is a schematic cross-sectional view of FIG. 14A. Referring to both FIGS. 14A and 14B, when the latching element 320 is in a locking position, the post 370 applies a force on the plunger 360 so that one end of a plunging elastic element 2342 and one end of the assisting elastic element 2350 incline downward in the normal direction N and store resilience.

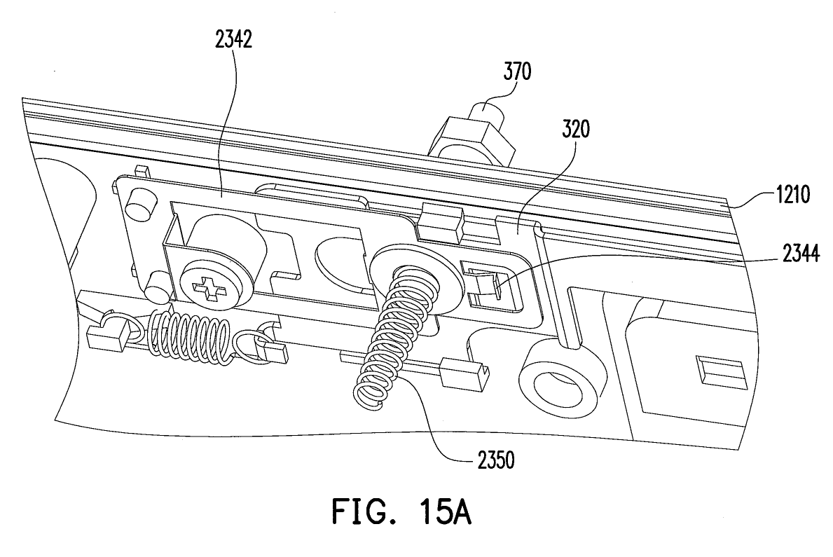

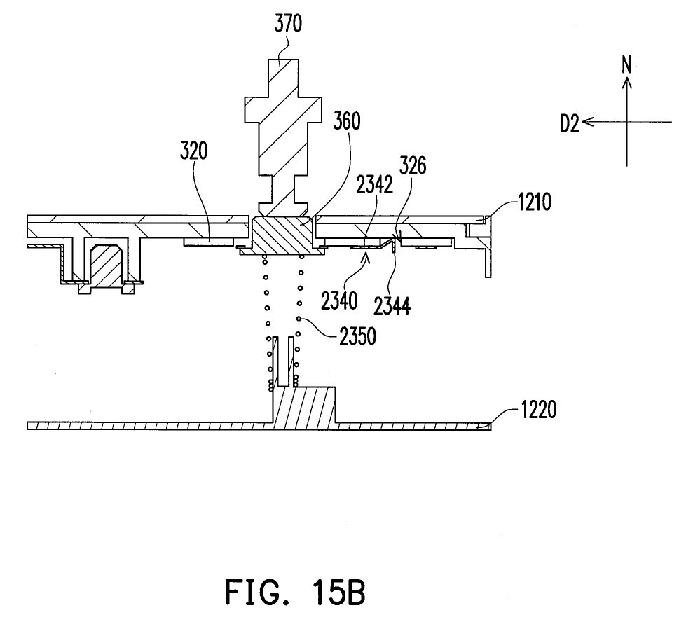

FIG. 15A is a schematic view of the fastening mechanism and the third housing when the latching element is moving and FIG. 15B is a schematic cross-sectional view of FIG. 15A. Referring to all FIGS. 12, 15A, and 15B, when a user pushes a press flange 2314 of the operating element 2310 in the direction D2, thereby driving the latching element 320 to move in the direction D2. After the post 370 is released from confinement, the resilience of the compression spring 380 moves the latching element 320 to move in a direction opposite to the direction D2. At the same time, the resilience of the assisting elastic element 2350 facilitates the plunging elastic element 2342 to push the plunger 360 to move upward in the normal direction N and the plunger 360 further pushes the post 370 to move upward.

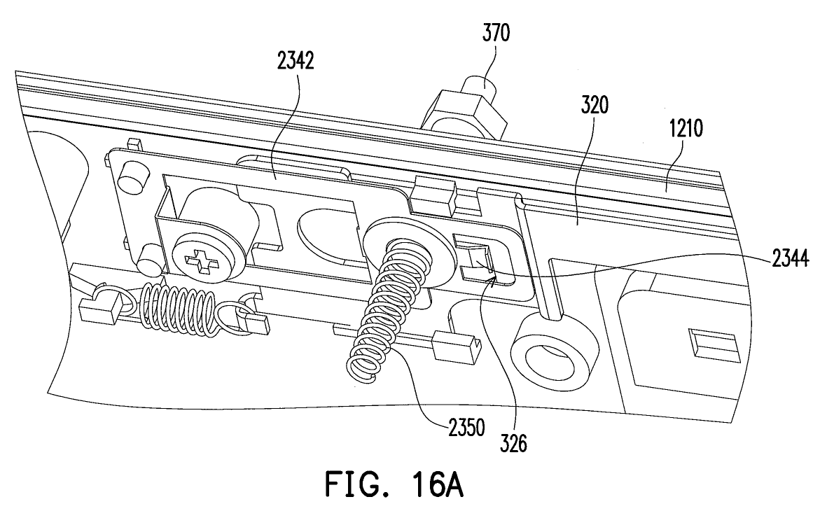

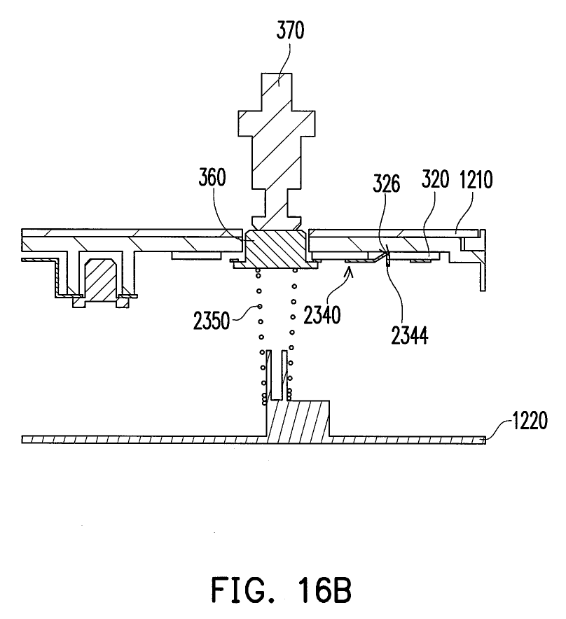

FIG. 16A is a schematic view of the fastening mechanism and the third housing when the latching element is in an unlocking position and FIG. 16B is a schematic cross-sectional view of FIG. 16A. Referring to both FIGS. 16A and 16B, when the latching element 320 is in an unlocking position, a stopping portion 2344 of the facilitating plunging elastic element 2342 of the plunger assembly 2340 presses against an edge of the limiting opening 326 of the latching element 320 to restrain a final position of the latching element 320. It should be mentioned that the stopping portion 2344 of the plunging elastic element 2342 of the plunger assembly 2340 may further extends a plane so that when the plunging elastic element 2342 driven by the resilience of the assisting elastic element 2350 pushes the plunger 360 to move upward, the plane can have a good contact with a plane of the latching element 320 to prevent the stopping portion 2344 from over-inclining upward and thus failing to properly restrain the position of the latching element 320.

In light of the above, the fastening mechanism of the present invention has a fewer number of magnesium and aluminum castings used in the device, resulting in lowered costs. In addition, the post, plunger assembly, assisting elastic element, and latching element are not precision elements and therefore have sizes for easy installation. Furthermore, the number of elements is relatively less and thus the fastening mechanism provides assembly personnel with convenience of installation and simplification in the assembly process. Moreover, the latching element of the fastening mechanism moves horizontally in a direction parallel to the inside surface and the assisting elastic element and the plunger move vertically in a direction perpendicular to the inside surface and such movements in two directions can reduce moving distance of the latching element and thus enable more ideal configuration of other electronic elements in the device or effectively minimize overall size of the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fastening mechanism, for being assembled in a device having a housing, the fastening mechanism comprising:
at least a post;
a latching element having at least an opening;
at least a plunger assembly disposed at a side of the latching element; and
an operating element contacting with the latching element,
wherein when the operating element is in a locking position, the post is inserted into the opening and presses against the plunger assembly and thereby the post is confined by the latching element, and
when the operating element moves to an unlocking position, the operating element drives the latching element to move horizontally in relation to the post such that the latching element releases the post from confinement, and the plunger assembly moves vertically in relation to the latching element to push the post out of the opening.

2. The fastening mechanism according to claim 1, wherein the operating element is a pressing element.

3. The fastening mechanism according to claim 1, wherein the operating element is a sliding element.

4. The fastening mechanism according to claim 1, wherein the operating element has a first inclined plane for guiding the latching element to move horizontally.

5. The fastening mechanism according to claim 4, further comprising a guiding block disposed on the latching element, wherein the guiding block has a second inclined plane contacting with the first inclined plane.

6. The fastening mechanism according to claim 1, further comprising an elastic component connected to the latching element to force the horizontally-moved latching element travel in a reverse direction.

7. The fastening mechanism according to claim 1, wherein the latching element is a flat linking element.

8. The fastening mechanism according to claim 1, wherein the operating element is a sliding bracket.

9. The fastening mechanism according to claim 1, wherein the plunger assembly comprises:
a plunging elastic element having a push force after being deformed; and
a plunger disposed on the plunging elastic element.

10. The fastening mechanism according to claim 9, wherein the plunger assembly further comprises a stopping portion to limit a distance of a return movement of the horizontally-moved latching element.

11. The fastening mechanism according to claim 10, wherein the stopping portion is disposed on the plunging elastic element.

12. The fastening mechanism according to claim 9, wherein the plunger assembly further comprises an assisting elastic element to increase a push force of the plunger assembly.

13. The fastening mechanism according to claim 12, wherein the assisting elastic element and the plunger are respectively disposed on two sides of the plunging elastic element.

14. The fastening mechanism according to claim 12, wherein the assisting elastic element and the plunging elastic element are integrally formed.

15. The fastening mechanism according to claim 12, wherein the plunging elastic element is an elastic plate.

16. The fastening mechanism according to claim 15, wherein the assisting elastic element is an elastic plate parallel to the plunging elastic element.

17. The fastening mechanism according to claim 12, wherein the assisting elastic element and the plunging elastic element are respectively assembled into the housing.

18. The fastening mechanism according to claim 12, wherein the assisting elastic element is a spring.

19. The fastening mechanism according to claim 18, wherein the housing has a first housing and a second housing, the first housing is suitable for opening and closing relatively to the second housing, the post is located in the first housing, and the latching element, the plunger assembly, and the operating element are disposed in the second housing.

20. The fastening mechanism according to claim 19, wherein the second housing comprises a third housing and a fourth housing, the plunging elastic element is assembled into the third housing, and the assisting elastic element is assembled into the fourth housing.
